(19) United States
(12) Patent Application Publication
(10) Pub. No.: US 2011/0154957 A1
(43) Pub. Date: Jun. 30, 2011

(54) PLIERS FOR CHAIN LINK

(76) Inventor: Wen-Pin WANG, An Ting Hsiang (TW)

(21) Appl. No.: 12/648,981

(22) Filed: Dec. 29, 2009

(51) Int. Cl. B25B 7/12; B25B 7/00

(52) U.S. Cl. 81/302; 81/427

(57) ABSTRACT

A pliers for chain link includes a left pliers body, a right pliers body, a pin and an elastic member. The left pliers body and the right pliers body are connected either in a parallel form or in a cross form. Center portions of the left and right pliers bodies are connected by the pin. The elastic member is located between the left and right pliers bodies. The left and the right pliers bodies includes clamping portions which have jaw parts. The jaw parts have curved edges thereon. The jaw part of the left pliers body corresponds to the jaw part of the right pliers body. The curved edges are adapted to lean against chain pins of chain plates to stabilize the operation of clamping.

### BACKGROUND OF THE INVENTION

1. Field of the Invention

The present invention relates to a pliers adapted to assemble chain plates of a bicycle chain, in particular to assemble or disassemble a self-clipped chain link of a bicycle chain.

2. Description of the Related Art

A conventional chain link of the bicycle chain commonly adds an exterior link plate and disposes respective annular grooves on either end or both ends of a chain pin. Concerning to the assembling, a C-shape buckling part is disposed relative to the exterior plate, by which the plate could be clasped on the annular groove to prevent the escape of the chain pin.

Further concerning to the detachment, the above typical invention needs to use specific tools to execute the dismantlement with following steps: initially fasten the chain link, force the exterior link plate to open, and thence extrude the chain pin out via a pusher. Such typical chain detacher is generally classified into IPC B21 L 21/00.

As in a prior invention, FIG. 1 of “KNUCKLE CONNECTOR FOR CONNECTING END KNUCKLES OF A CHAIN STRAND” published by U.S. Pat. No. 5,291,730, or another prior invention, FIG. 1 to FIG. 3 of “MASTER CHAIN LINK” published by U.S. Pat. No. 5,362,282, mainly directed to a chain link configuration. It should note that nowhere professional or specific tools could be in normal to the detachment of such chain link. Instead, a commonly manual tool is well-known used to accomplish its detachment, for instance of a long flat nose pliers which could be utilized to forcedly propel the chain pin from the buckled groove into a free orifice. Similarly, to assemble this chain link, the same tool is also used for pushing the chain pin from the orifice into the groove. However, the typical master chain link facilely cause the chain pin slipped and inconvenient operation as a result of the pin formed of an arcuate contour that leads to the chain pin merely contacting with the jaw part of the pliers at one point.

Further, to assemble the chain plates, it is required to use the pliers to force the pin into the engaging hole, which also has the same problem.

### SUMMARY OF THE INVENTION

In view of the above mentioned shortcomings, the present invention is to provide a pliers for chain link, which has curved edges provided on jaw parts of clamping portions of the pliers. The curved edges are adapted to lean against arc surfaces of a chain pin so as to correct the slippery issue.

According to the present invention, there is provided a pliers for chain link, which comprises a left pliers body, a right pliers body, a pin and an elastic member. The left pliers body and the right pliers body are connected either in a parallel form or in a cross form. Center portions of the left and right pliers bodies are connected by the pin. The elastic member is located between the left and right pliers bodies. Since the left pliers body and the right pliers body are identical, only one will be described hereinafter. The left pliers body comprises a handle, a connecting portion connected to the handle, and a clamping portion connected to the connecting portion. The connecting portion has a through hole. The clamping portion has a jaw part extending from a distal end thereof. At least one of the jaw parts of the left and right pliers bodies has a curved edge. The pin is inserted through the through holes of the left pliers body and the right pliers body to connect the left and right pliers bodies together. The jaw part of the left pliers body corresponds to the jaw part of the right pliers body. The elastic member has two opposite ends, with one end inserted into a fixing hole of the handle of the left pliers body and the other end inserted into a fixing hole of the handle of the right pliers body, such that the elastic member is positioned between the handle of the left pliers body and the handle of the right pliers body.

Preferably, the left pliers body and the right pliers body are connected in a parallel form. Both the jaw parts of the left pliers body and the right pliers body have curve edges which are disposed in opposite directions.

Alternatively, the left pliers body and the right pliers body are connected in a cross form. Both the jaw parts of the left pliers body and the right pliers body have curve edges which are disposed to face with each other.

Preferably, the curved edge has an arc shape, is formed with teeth, or has an arc shape with teeth thereon.

It is the primary object of the present invention to provide a pliers for chain link, which can hold chain plates firmly.

It is another object of the present invention to provide a pliers for chain link, which is easy to operate.

### BRIEF DESCRIPTION OF THE DRAWINGS

FIG. 1 is an exploded view according to a first embodiment of the present invention;

FIG. 2 is a perspective view according to the first embodiment of the present invention;

FIG. 3 is a perspective view showing that the jaw parts of the pliers are inserted in chain plates according to the first embodiment of the present invention;

FIG. 4 is a perspective view showing that the chain pins are assembled according to the first embodiment of the present invention;

FIG. 5 is an exploded view according to a second embodiment of the present invention;

FIG. 6 is a perspective view according to the second embodiment of the present invention;

FIG. 7 is a perspective view showing that the jaw parts of the pliers are inserted in chain plates according to the second embodiment of the present invention; and

FIG. 8 is a perspective view showing that the chain pins are disassembled according to the second embodiment of the present invention.

### DETAILED DESCRIPTION OF THE PREFERRED EMBODIMENTS

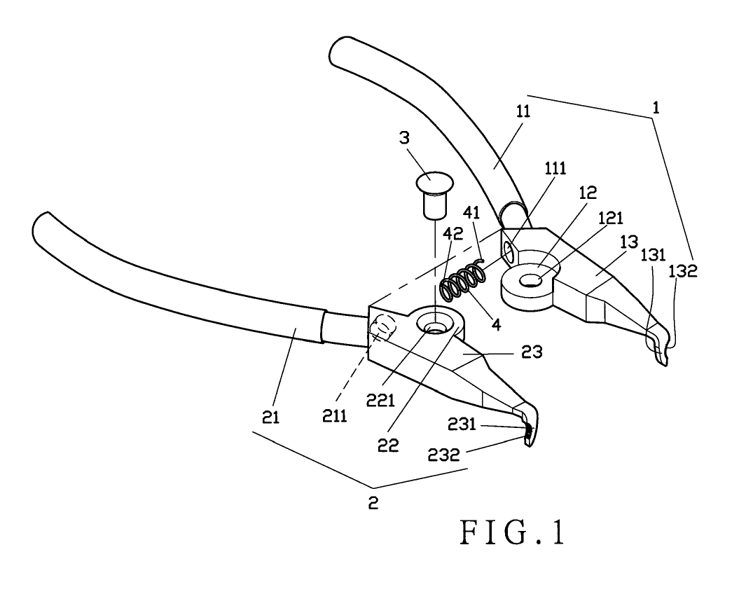

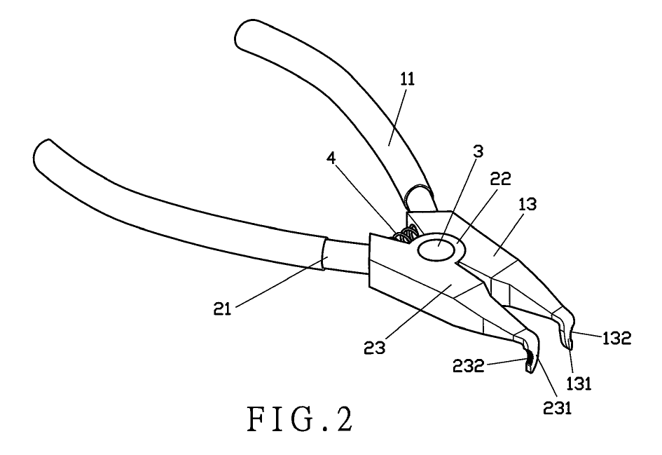

As shown in FIGS. 1 and 2, a first embodiment of the present invention comprises a left pliers body 1, a right pliers body 2, a pin 3 and an elastic member 4. The left pliers body 1 and the right pliers body 2 are connected in a parallel form. Central portions of the left pliers body 1 and the right pliers body 2 are pivoted by the pin 3. The elastic member 4 is located between the left pliers body 1 and the right pliers body 2.

The left pliers body 1 comprises a handle 11, a connecting portion 12 connected to the handle 11, and a clamping portion 13 connected to the connecting portion 12. The handle 11 has a fixing hole 111 disposed adjacent to the connecting portion 12. The connecting portion 12 has a through hole 121 thereon. The clamping portion 13 comprises a jaw part 131 bending from a distal end thereof. The jaw part 131 has a curved edge 132 thereon. The curved edge 132 has an arc shape with teeth thereon.

The right pliers body 2 comprises a handle 21, a connecting portion 22 connected to the handle 21, and a clamping portion 23 connected to the connecting portion 22. The handle 21 has a fixing hole 211 disposed adjacent to the connecting portion 22. The connecting portion 22 has a through hole 221 thereon. The clamping portion 23 comprises a jaw part 231 bending from a distal end thereof. The jaw part 231 has a curved edge 232 thereon. The curved edge 232 has an arc shape with teeth thereon.

The pin 3 is inserted in the through hole 121 of the left pliers body 1 and the through hole 221 of the right pliers body 2 to connect the left pliers body 1 and the right pliers body 2 together. The jaw part 131 of the left pliers body 1 corresponds to the jaw part 231 of the right pliers body 2.

The elastic member 4 has two opposite ends 41 and 42, with one end inserted into the fixing hole 111 of the handle 11 of the left pliers body 1 and the other end inserted into the fixing hole 211 of the handle 21 of the right pliers body 2, such that the elastic member 4 is positioned between the handle 11 of the left pliers body 1 and the handle 21 of the right pliers body 2.

In this embodiment, the left pliers body 1 and the right pliers body 2 are disposed in a parallel form, with the connecting portions 12 and 22 overlapped. The curved edge 132 on the jaw part 131 of the left pliers body 1 and the curved edge 232 on the jaw part 231 of the right pliers body 2 are disposed in opposite directions.

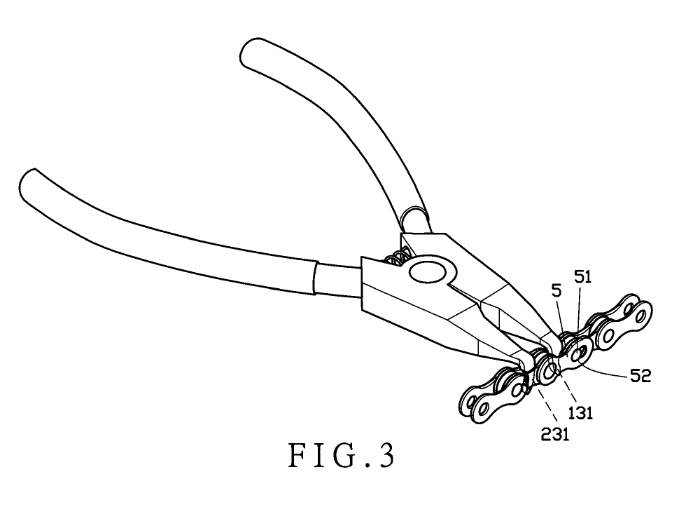

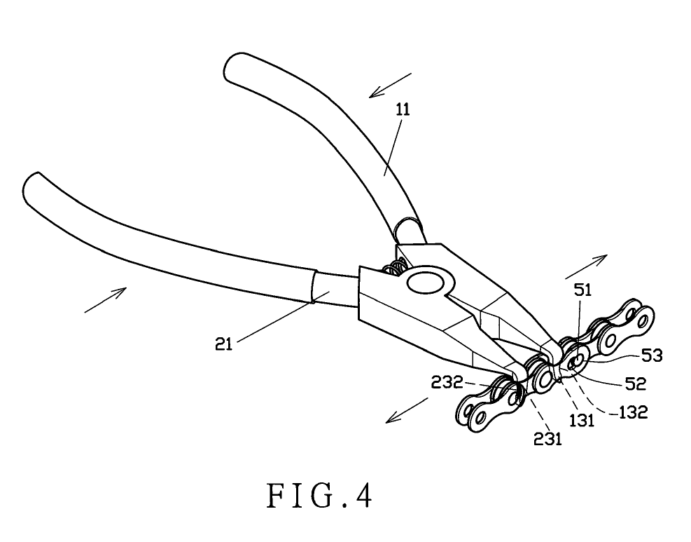

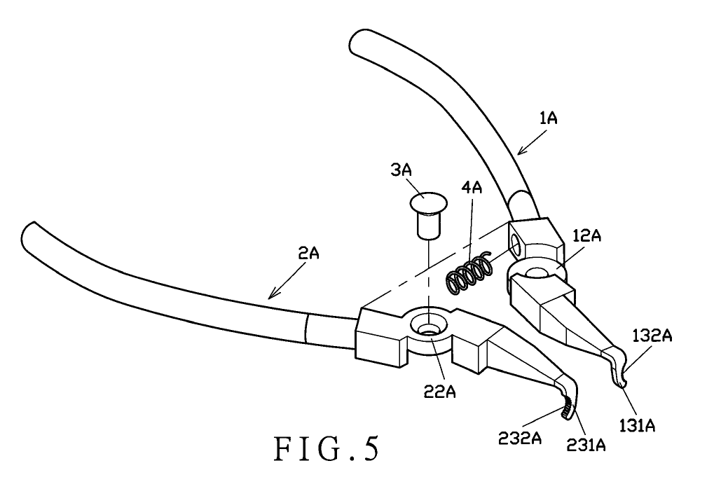

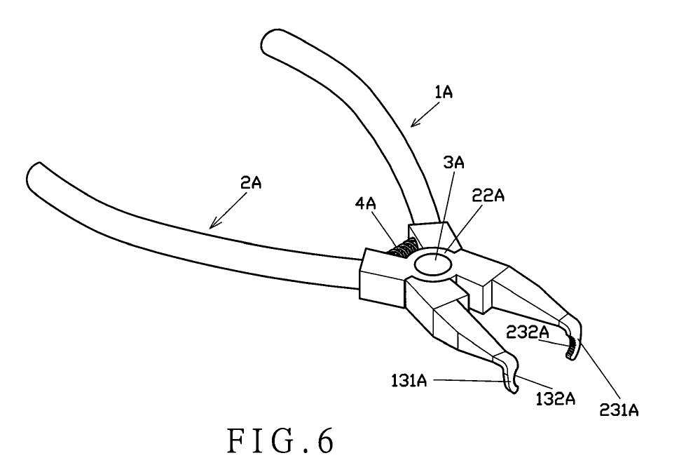

This embodiment is adapted to assemble a chain link. As shown in FIG. 3, the jaw parts 131, 231 are inserted into an interstice between adjacent chain pins of a chain link. Wherein, one chain pin 51 of chain plates 5 is inserted in an disengaging hole 52. As shown in FIG. 4, one of the curved edges 132, 232 is against the chain pin 51. The handles 11, 21 are constricted to expand the two jaw parts 131, 231, such that the chain pin 51 is pushed to enter an engaging hole 53 for positioning. During this operation, the curved edges 132, 232 lean against arc surfaces of the chain pin 51, without disengagement. This embodiment also can be used to disassemble the chain link. However, it is laborious for the chain pin 51 to escape from the engaging hole 53 to the disengaging hole 52. But if the force is applied to the chain pin 51 from outside to inside, the operation will be easier. Therefore, a second embodiment is provided as shown in FIGS. 5 and 6.

In FIGS. 5 and 6, the left pliers body 1A and the right pliers body 2A are connected by the pin 3A. The elastic member 4A is provided between the left pliers body 1A and the right pliers body 2A. The difference between the first and the second embodiments is that the left pliers body 1A and the right pliers body 2A are connected in a cross form, with the connecting portions 12A and 22A overlapped. The curved edge 132A of the jaw part 131A of the left pliers body 1 and the curved edge 232A of the jaw part 231A of the right pliers body 2 are disposed to face with each other.

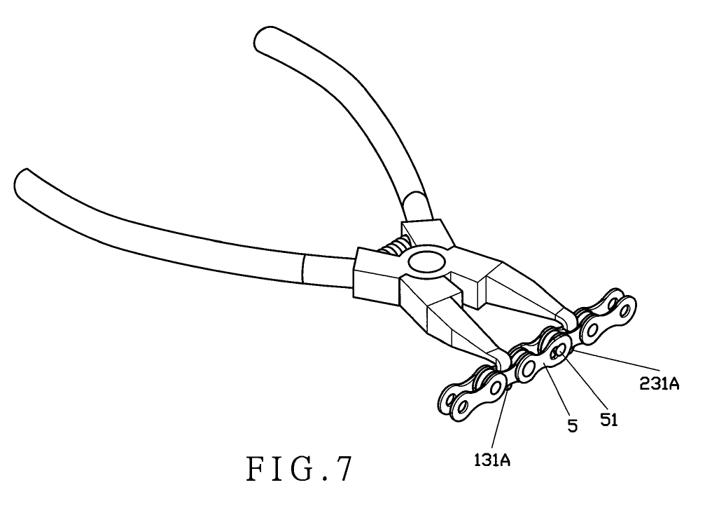

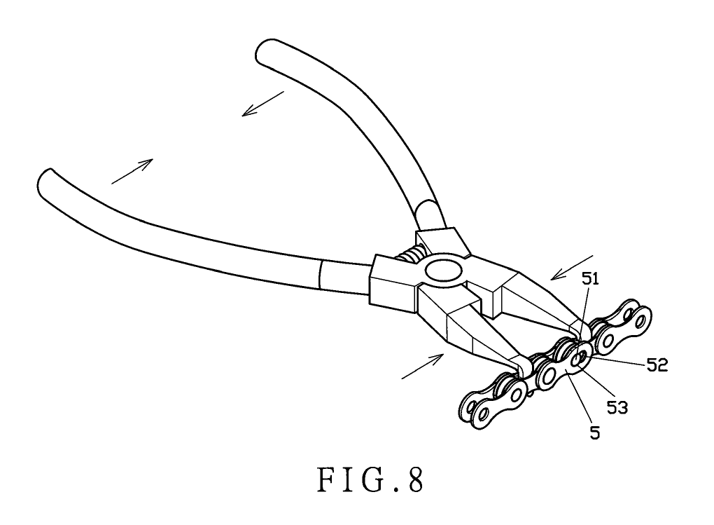

To disassemble the chain plates 5, as shown in FIG. 7, the jaw parts 131A and 231A are inserted to lean against the arc surfaces of the chain pins 51 of the chain plates 5. As shown in FIG. 8, the chain pin 51 is pushed from the engaging hole 53 to the disengaging hole 52 so as to disassemble the chain plates 5. During this operation, the curved edges 132A and 232A lean against the arc surfaces of the chain pins 51 firmly.

According to the above description, one can find that the curved edges 132, 232, 132A and 232A are the major object to facilitate the assembly or disassembly process more securely.

What is claimed is:

1. A pliers for chain link, comprising a left pliers body, a right pliers body, a pin, and an elastic member, the left pliers body and the right pliers body being connected in a parallel form, central portions of the left pliers body and the right pliers body being pivoted by the pin, the elastic member being located between the left pliers body and the right pliers body, the left pliers body and the right pliers body comprising clamping portions, the clamping portions comprising jaw parts, at least one of the jaw parts having a curved edge thereon, the jaw part of the left pliers body corresponding to the jaw part of the right pliers body.

2. The pliers as claimed in claim 1, wherein the curved edge has an arc shape.

3. The pliers as claimed in claim 1, wherein the curved edge has teeth thereon.

4. The pliers as claimed in claim 1, wherein the curved edge has an arc shape with teeth thereon.

5. The pliers as claimed in claim 1, wherein the jaw parts of the left pliers body and the right pliers body have curve edges which are disposed in opposite directions.

6. A pliers for chain link, comprising a left pliers body, a right pliers body, a pin and an elastic member, the left pliers body and the right pliers body being connected in a cross form, central portions of the left pliers body and the right pliers body being pivoted by the pin, the elastic member being located between the left pliers body and the right pliers body, the left pliers body and the right pliers body comprising clamping portions, the clamping portions comprising jaw parts, at least one of the jaw parts having a curved edge thereon, the jaw part of the left pliers body corresponding to the jaw part of the right pliers body

7. The pliers as claimed in claim 6, wherein the curved edge has an arc shape.

8. The pliers as claimed in claim 6, wherein the curved edge has teeth thereon.

9. The pliers as claimed in claim 6, wherein the curved edge has an arc shape with teeth thereon.

10. The pliers as claimed in claim 6, wherein the jaw parts of the left pliers body and the right pliers body have curve edges which are disposed to face with each other.
